(19) United States
(12) Patent Application Publication
(10) Pub. No.: US 2014/0299818 A1
(43) Pub. Date: Oct. 9, 2014

(54) GRAPHENE / CARBON COMPOSITIONS

(71) Applicants: Inhwan Do, East Lansing, MI (US); Hyunjoong Kim, East Lansing, MI (US)

(72) Inventors: Inhwan Do, East Lansing, MI (US); Hyunjoong Kim, East Lansing, MI (US)

(21) Appl. No.: 14/201,986

(22) Filed: Mar. 10, 2014

Related U.S. Application Data
(60) Provisional application No. 61/786,735, filed on Mar. 15, 2013.

(51) Int. Cl. H01G 11/36

(52) U.S. Cl. CPC H01G 11/36
USPC 252/502

(57) ABSTRACT

High surface area nano sized graphene and carbon compositions.

This invention was made with Government support under contract FA9453-12-M-0032 awarded by the United States Air Force. The Government has certain rights in the invention.

This application claims priority from U.S. Provisional Patent application Ser. No. 61/786,733, filed Mar. 15, 2013.

BACKGROUND OF THE INVENTION

The instant invention deals with new compositions of matter.

The invention uses high surface area nano sized graphene and carbon for capacitors, Graphene/carbon hybrid electrodes exhibit synergic effects on the performance enhancement of electrochemical capacitors. Both forms of activated carbon act as an active material and graphene acts as an active material.

Activated carbons are materials commonly used in commercial electrochemical capacitors. However, they do not deliver sufficient performance necessary for applications requiring high energy and power density. This lack of performance is due to poor electrical conductivity and poor ion transport caused by very wide size distributions of randomly interconnected inner micropores.

Graphene is used in electrochemical capacitors due to its high surface area, high mechanical and electrical properties, highly inert surface properties, low impurities, and the like. Nano sized graphene consists mostly of mesopores and macropores and thus the surface area of the nano sized graphene is accessible by even fairly large electrolyte ions. The nano sized graphene with surface areas of 600 m²/g shows very high specific capacitance outperforming the new carbon nanostructures such as single walled and double walled carbon nanotubes having comparable surface areas to nano sized graphene.

The graphene reduces the cost of the electrode by replacing high cost activated carbon with lower cost graphene while improving energy storage by at least 5 to 20%. The graphene also acts as an ion migration catalyst to increase both energy and power density. Internal resistance is also reduced.

The process and materials of this invention are different from any found in the prior art. The only reference that calls directly for using carbon black and graphene in an electrode together does so only to increase the conduction with a metal based active material. It is not shown or suggested that the active material is an activated carbon enhanced with graphene.

Such a disclosure can be found in U.S. 2012/0088156A wherein the application teaches a multistep method to produce electrodes that includes adding graphene oxide to an electrode mixture and reducing the graphene oxide to graphene. One of the dependent claims includes adding less than 1% conductive, auxiliary agent that may be carbon black.

### The Invention

Thus, what is disclosed and claimed herein as one embodiment is a composition of matter comprising a combination of a high surface area nano sized graphite and carbon. The graphites are nanosized graphene nanotubes and nanosized graphene nanoplatelets and the carbons can be for example, activated carbon, carbon black, and carbon nanofibers and carbon aerogels.

Also, there is present in this invention a method for manufacturing a composition as set forth Supra. The process of manufacturing comprises dispersing graphene in a suitable solvent, dispersing carbon in a suitable solvent, combining and mixing the products together to form a slurry, filtering the slurry to provide a sheet form, drying the sheet, and, calendaring the sheet to a desired thickness and surface finish.

### BRIEF DESCRIPTION OF THE DRAWINGS

FIG. 1 is a chart of Galvanostatic charge/discharge for the electrochemical characterization of the material prepared in example 1 with gravimetric capacitance in F/g (faraday/gram) versus current density in A/g (amps/gram).

FIG. 2 is a chart of volumetric capacitance with Current Density in A/g versus Volumetric Capacitance in F/cm³.

FIG. 3 is a chart of gravimetric energy in Wh/kg versus Current Density in A/g.

FIG. 4 is a chart, of Volumetric Energy in mWh/cm³ versus Current Density in A/g.

FIG. 5 is a chart of Gravimetric Power in kW/kg versus Current Density in A/g.

FIG. 6 is a chart of volumetric Power in W/cm³ versus Current density in A/g.

FIG. 7 is a chart of capacitance in F/g versus Current density in A/g.

FIG. 8 is a chart of energy density in Wh/Kg versus Current density in A/g.

### DETAILED DESCRIPTION OF THE INVENTION

The instant invention deals with the addition of graphene into activated carbon. The carbon useful herein has an average size of between 10 nanometer and 100 microns and a BET surface area greater than about 300 m²/g. The graphene has a size between 30 nanometers and 50 microns and a BET surface of greater than about 300 m²/g. In addition, the graphene has an aspect ratio between about 25 and 25,000. The graphene to carbon ratio is between 0.5 and 10.

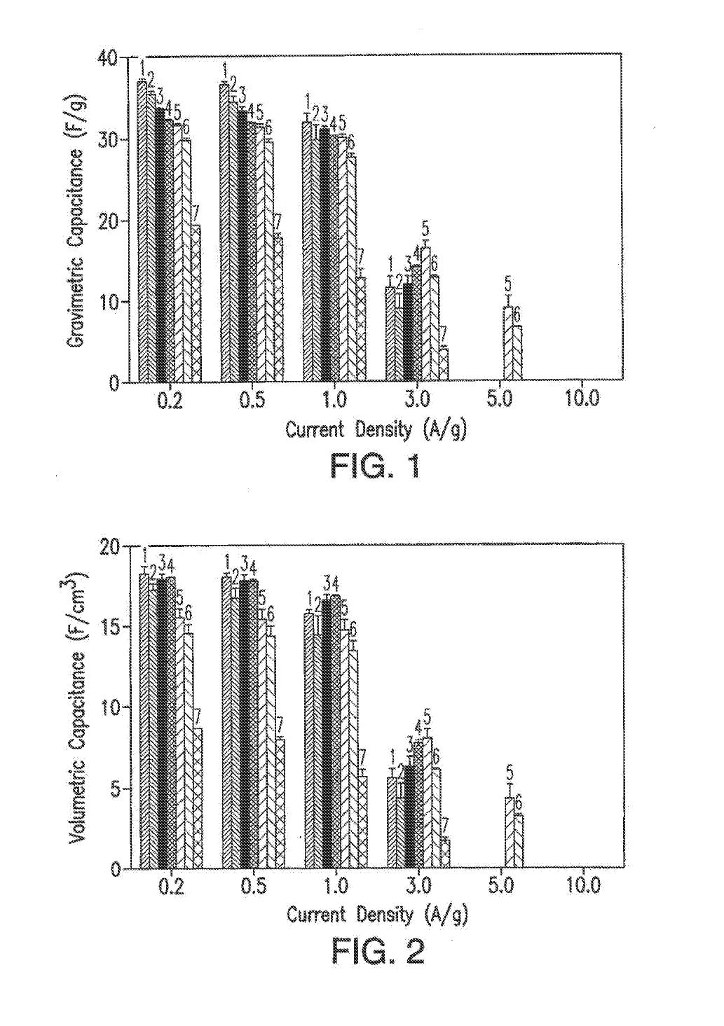

In FIGS. 1 to 6, 1 designates 100% YP50F; 2 designates 90% YP50F and 10% C750; 3 designates 80% YP50F and 20% C750; 4 designates 70% YP50F and 30% C750; 5 designates 60% YP50F and 40% C750; 6 designates 5.0% YP50F and 50% C7S0, weight ratios.

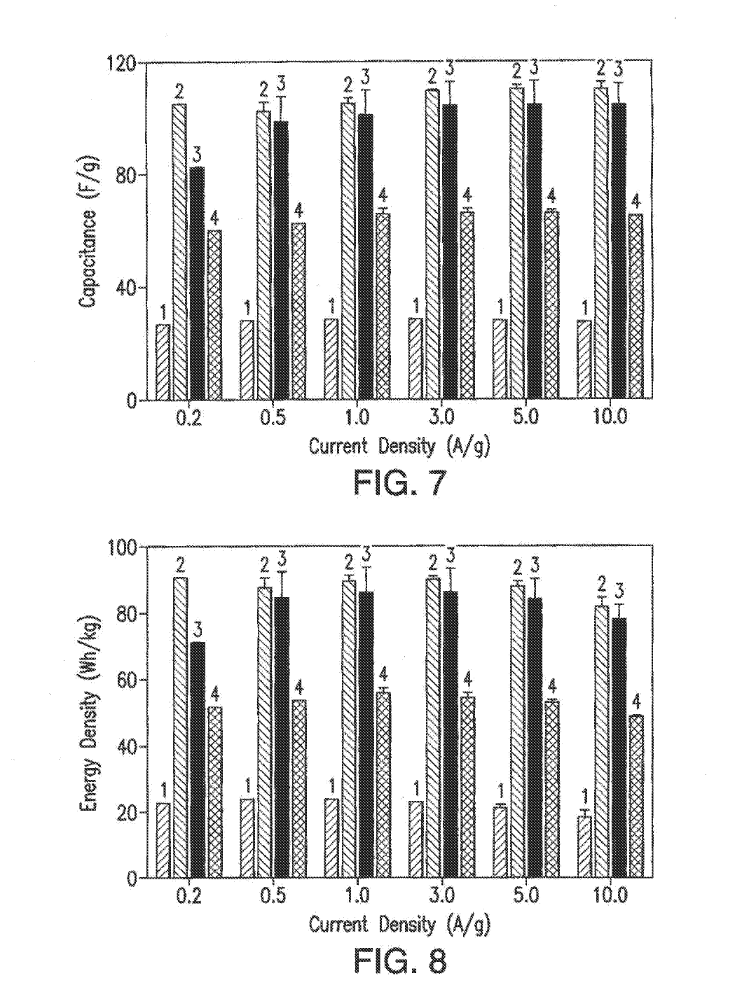

In FIGS. 7 and 8, 1 designates 100% xGnP Xg Sciences graphene; 2 designates 90% activated carbon and 10% xGnP; 3 designates 100% Kansai activated carbon; and 4 designates 100% YP50F activated carbon.

### EXAMPLES

### Example 1

Commercial activated carbon (ACTIVATED CARBON:YP-50F, 1500 m²/g, Kurary Chemical Company) and nanosized graphene: C-750, 750 m²/g, XG Sciences, Lansing, Mich.) were used as the active materials in this example. Carbon black (Super C, Timcal) and PVDF were used as conductive agents and polymeric binder, respectively. The paste consisting of typical weight ratio of active carbon:nano sized graphene:Super-C:PVDF=88:7:5 was coated on aluminum foil via a doctor blade method. Galvanostatic charge/discharge for electrochemical characterization was performed in 1M TEABF₄/acetonitrile electrolyte in the range of 0-2.5V.

While no synergic effect for the hydbridization of nano sized graphene with activated carbon was shown at low current density (<A/g), the capacitance of nano sized graphene/activated carbon electrode was increased over activated carbon alone electrode at high current density (>1A/g). The addition of 30% to 40% of nano sized graphene seems optimal to achieve the best synergic effect. See FIGS. 1 and 2.

Energy density was compared. The behavior of gravimetric energy density as a function of current density was similar to that of capacitance. However, the volumetric energy density of nano sized graphene/activated carbon electrode was higher than that of activated carbon electrode regardless of current density.

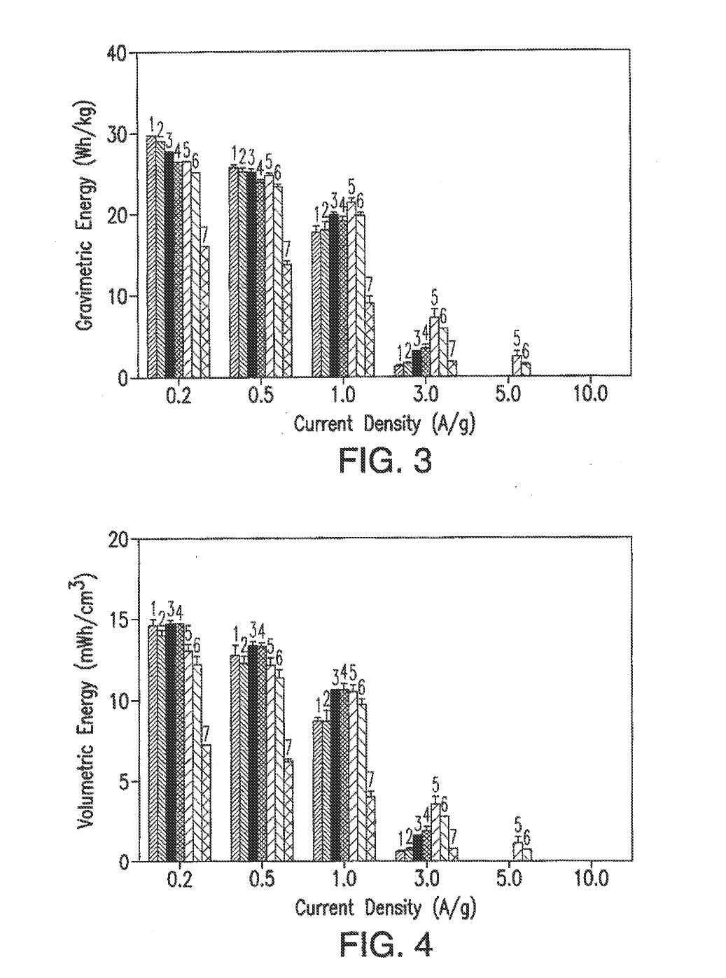

Power density was compared. Both gravimetric and volumetric powder density were increased for the nano sized graphene/activated carbon electrodes regardless of current density and nano sized graphene content due to excellent conductivity of the nano sized graphene. See also FIGS. 3 and 4.

### Example 2.

Two commercial activated carbons were used as active component: YP-50F (1500 m²/g, Kuraray Chemical Company and MSP-20 (2200 m²/g, Kansai Chemical Company. Nanosized graphene (C-750, 750 m²/g, and multi-walled carbon nanotubes (230 m²/g, Hanwha Nanotech) were used as another active material and the binder, respectively. Activated carbon or the activated carbon/nano sized graphene was dispersed in isopropyl alcohol using a bath type sonicator for 60 minutes and carbon nano tubes was also separately sonicated in Isopropyl alcohol for 1 hour. The dispersed activated, carbon and the carbon nano tubes solutions were combined, followed by additional 60 minutes sonication. Then, the activated, carbon-carbon nano tubes and activated carbon/nano sized graphene-carbon nanotubes dispersion (ink) was filtered using a membrane filtration system. After drying at 80°C. under vacuum for 2 hours, the activated carbon-carbon nano tubes and activated carbon/nano sized graphene-carbon nano tube free standing paper were calendared on Ni foam. Electrochemical tests for 2016 coin cell with two identical activated carbon-carbon nano tube electrodes was done in 1M TEABF₄/acetonitrile electrolyte.

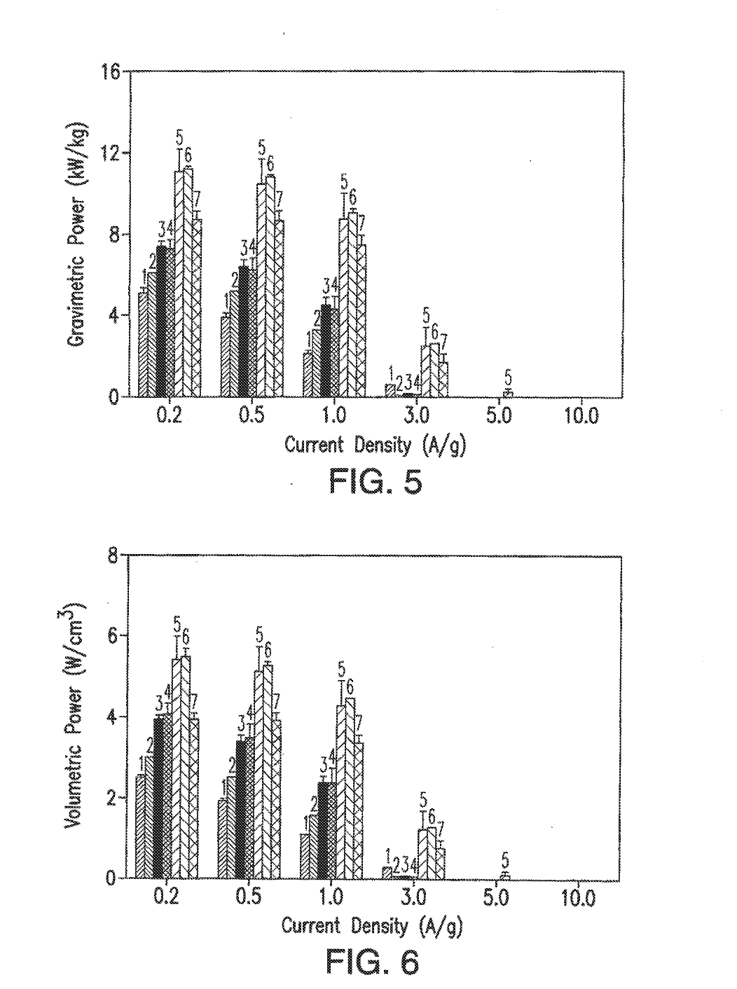

The specific capacitance and energy density of activated carbon/nano sized graphene-carbon nano tube electrode shows higher than that of activated carbon-carbon nano tube electrodes, which confirms the synergistic effect of the hybridization of activated carbon-nano sized graphene as co-active materials for electrochemical capacitors. See FIGS. 5 and 6.

What is claimed is:

1. A composition of matter comprising a combination of a high surface area nanosized graphite, and carbon wherein the nanosized graphite is selected from, the group consisting of nanosized graphene nanotubes and nanosized graphene nanoplatelets.

2. A composition of matter as claimed in claim 1 wherein the carbon is selected from the group consisting essentially of:
a. activated carbon;
b. carbon black, and,
c. carbon nanofibers, and,
d. carbon aerogels.

3. A process of manufacturing a composition as claimed in claim 3, said method comprising:
i. dispersing graphene in a suitable solvent;
ii. dispersing carbon in a suitable solvent.
iii. combine and mix the products of i and ii to form a slurry;
iv. filtering said slurry to provide a sheet form;
v. drying the sheet formed in iv.;
vi. calendaring said sheet to a desired thickness and surface finish.
